(19) United States
(12) Patent Application Publication
(10) Pub. No.: US 2018/0308373 A1
(43) Pub. Date: Oct. 25, 2018

(54) EDUCATIONAL DISPLAY DEVICES AND METHODS FOR USING SAME

(71) Applicant: BOGLE MARKETING LLC, Alpharetta, GA (US)

(72) Inventors: NATALIE BOGLE, Alpharetta, GA (US); NICHOLAS BOGLE, Alpharetta, GA (US)

(21) Appl. No.: 15/957,880

(22) Filed: Apr. 19, 2018

Related U.S. Application Data
(60) Provisional application No. 62/487,067, filed on Apr. 19, 2017.

(51) Int. Cl. G09B 1/06; G09B 17/00; G09B 19/02

(52) U.S. Cl. CPC G09B 1/06; G09B 19/02; G09B 17/00

(57) ABSTRACT

Disclosed herein are interactive display devices and systems for teaching and educating a child comprising: a display assembly, the display assembly comprising: a display frame defining an outer edge of the display assembly; and a plurality of display members, the display members being contained within the display assembly edge; a plurality of cards comprising indicia disposed on at least one surface of the card, the cards being configured to be releasably attached to the display members in an attachment pattern; and a plurality of securing means configured to releasably attach the cards to the display members; wherein the card indicia are configured to communicate information for use in determining a card attachment position in the attachment pattern. Also disclosed herein are methods for using the disclosed devices and systems.

### CROSS REFERENCE TO RELATED APPLICATIONS

This application claims the benefit of priority to U.S. Provisional Patent Application Ser. No. 62/487,067, filed Apr. 19, 2017, which is hereby incorporated herein by reference in its entirety.

### FIELD OF INVENTION

The present invention relates to educational display devices and methods for using the same; more particularly, improved display devices and methods of using the display device for teaching children.

### BACKGROUND OF THE INVENTION

Interactive educational methods are understood to be more effective at teaching skills than traditional lecturing methods where the student is passively receiving the lesson. Games and activities that require the student to actively participate are being used in a variety of teaching settings. Early childhood education has also received a lot of attention due to the understanding that earlier exposure to education can lead to better outcomes once a student enters the formal educational system.

Accordingly, there remains a need for improved education methods, devices and systems that effectively teach pre-reading and pre-math skills in an interactive way, while strengthening fine motor skills and improving hand-eye coordination. This need and other needs are satisfied by the various aspects of the present disclosure.

### SUMMARY OF THE INVENTION

In accordance with the purposes of the invention, as embodied and broadly described herein, the invention, in one aspect, relates to educational display devices and systems and methods for using the same. In various aspects, the disclosed devices, systems and method can teach basic skills to children in an entertaining and interactive way.

In another exemplary aspect, the invention relates to an interactive display system for teaching and educating a child, the system comprising: a display assembly, the display assembly comprising: a display frame defining an outer edge of the display assembly; and a plurality of display members, the display members being contained within the display assembly edge; a plurality of cards comprising indicia disposed on at least one surface of the card, the cards being configured to be releasably attached to the display members in an attachment pattern; and a plurality of securing means configured to releasably attach the cards to the display members; wherein the card indicia are configured to communicate information for use in determining a card attachment position in the attachment pattern.

In further aspects, the invention also relates to methods for using the disclosed devices and systems, and kits comprising the disclosed devices and systems.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIG. 1 shows a depiction of a display assembly comprising a display frame and a plurality of display elements in accordance with an exemplary embodiment of the present invention.

FIG. 2 shows a depiction of an interactive display system for teaching and educating a child comprising a display assembly, a plurality of cards, and a plurality of securing members in accordance with an exemplary embodiment of the present invention.

FIG. 3 shows a method for using the disclosed devices and systems in accordance with another exemplary embodiment of the present invention.

### DETAILED DESCRIPTION OF THE INVENTION

The present invention can be understood more readily by reference to the following detailed description of the invention and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms which shall be defined herein.

As used in the specification and the appended claims, the singular forms “a,” “an” and “the” include plural referents unless the context clearly dictates otherwise. Thus, for example, reference to “an element” includes two or more elements.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Disclosed are the components to be used to manufacture the disclosed devices and articles of the invention as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the invention. Thus, if there are a variety of additional steps that can be performed it is understood that each of these additional steps can be performed with any specific aspect or combination of aspects of the methods of the invention.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. Educational Display Devices and Systems

As briefly described above, the present disclosure relates, in various aspects, to interactive display devices and systems for teaching children. In further aspects, the present unique learning system encourages children to learn, for example, basic pre-reading and pre-math skills, in a fun and interactive way. In still further aspects, basic pre-reading skills may comprise at least one of: letter knowledge, identification and naming letters; identification and naming each letters sound; recognizing lowercase and capital letters; rhyming, counting syllables in a word; blending sounds together, and the like. In even further aspects, pre-math skills can comprise at least one of: learning proper sequencing of numbers; repeating patterns; sorting using different criteria; concepts of bigger, smaller, more, less, fewer, most, least, and the like. In yet further aspects, the disclosed devices and systems use the display assembly and cards to introduce concepts related to letters, numbers, shapes and colors in a creative and fully engaging way.

In one aspect, the present disclosure provides an interactive display system for teaching and educating a child, the system comprising: a display assembly, the display assembly comprising: a display frame defining an outer edge of the display assembly; and a plurality of display members, the display members being contained within the display assembly edge; a plurality of cards comprising indicia disposed on at least one surface of the card, the cards being configured to be releasably attached to the display members in an attachment pattern; and a plurality of securing means configured to releasably attach the cards to the display members; wherein the card indicia are configured to communicate information for use in determining a card attachment position in the attachment pattern.

In further aspects, each card can have a predetermined relationship to another card in an adjacent position. In still further aspects, the card information can be used in determining a relationship between one or more cards. In yet further aspects, the card indicia can comprise an alphanumerical character, object, shape, picture, symbol, icon, color, media, or combinations thereof. In even further aspects, the relationship can comprise letter-word association, letter-word sound association, phonemic association, number association, letter-letter association, color-letter association, numerical value, shape association, sorting, patterning and combinations thereof.

In some aspects, the relationship can comprise at least one card having a predetermined letter of a predetermined alphabet and at least one card having a predetermined picture of at least one object of a person, an animal, or thing being identifiable by a word which is spelled having a first letter substantially identical to the predetermined letter. In other aspects, the relationship can comprise a first card having a predetermined picture of at least one object of a person, an animal, and a thing being identifiable by a word having a first letter, and at least one other card having a predetermined picture of at least one object of a person, an animal, and a thing being describable by a word which is spelled using substantially the same first letter from the first card. In yet other aspects, the relationship can comprise at least one card having a predetermined numerical character and at least one card having a predetermined picture of a predetermined number of objects; wherein the predetermined number of objects is substantially equal to the predetermined numerical character.

In further aspects, the card can comprise alphabet cards, picture cards, number cards, and combinations thereof. In still further aspects, the alphabet cards can comprise uppercase and lowercase versions of a particular letter, consonants or vowels, or combinations thereof. For example, a first card can show an uppercase “B” and second card can show a lowercase “b”. In yet further aspects, consonant letter can be selected from the uppercase and lowercase consonants B, C, D, F, G, H, J, K, L, M, N P, Q, R, S, T, V, W, X, Y, Z. In even further aspects, vowel cards can be selected from the uppercase and lowercase vowels A, E, I, O, and U.

In further aspects, the consonant cards and vowel cards can comprise the same or different colors. In still further aspects, the uppercase cards and lowercase cards can comprise different colors. For example, uppercase cards are one color (such as red), while the lowercase blocks are a different color (such as blue).

In further aspects, the cards can comprise pictures that are selected so that the descriptive word for each picture starts with the same letter. For example, picture cards corresponding to letter card “A” show an apple, an ant, and an alien. Picture cards corresponding to letter card “E” show an elephant, an eagle, and an egg. In further aspects, examples of the pictures found on a (consonant) picture card for the letter B are depictions or symbols of a ball and bear. In yet further aspects, vowel picture cards for the letter A can have depictions of an apple, alligator, and alien.

In further aspects, the display assembly can further comprise at least one receptacle for storing the cards, securing means, or combinations thereof. In yet further aspects, the display assembly can comprise a plurality of receptacles. In still further aspects, the storage receptacles can be disposed on an outer edge of the display frame.

In further aspects, the display frame can be comprised of a rigid material. In still further aspects, the rigid material can comprise a metal, wood, or thermoplastic, or a combination thereof. In yet further aspects, the display frame can be in the shape of a square, rectangle, polygon, isosoles trapezoid, or a combination thereof. In even further aspects, the display frame can comprise a plurality of connected frame elements. In still further aspects, the frame elements can be connected by a coupling means. In yet further aspects, the coupling means can comprise a fitting, flange, joint, coupling, insert, threading, friction fit, snap-fit or other suitable type of connecting mechanism, or a combination thereof. In further aspects, the securing means can comprise a clamp, clip, clasp, pin, strap, hooks, snap, band, fastener, or other suitable type of releasable attachment mechanism, or a combination thereof.

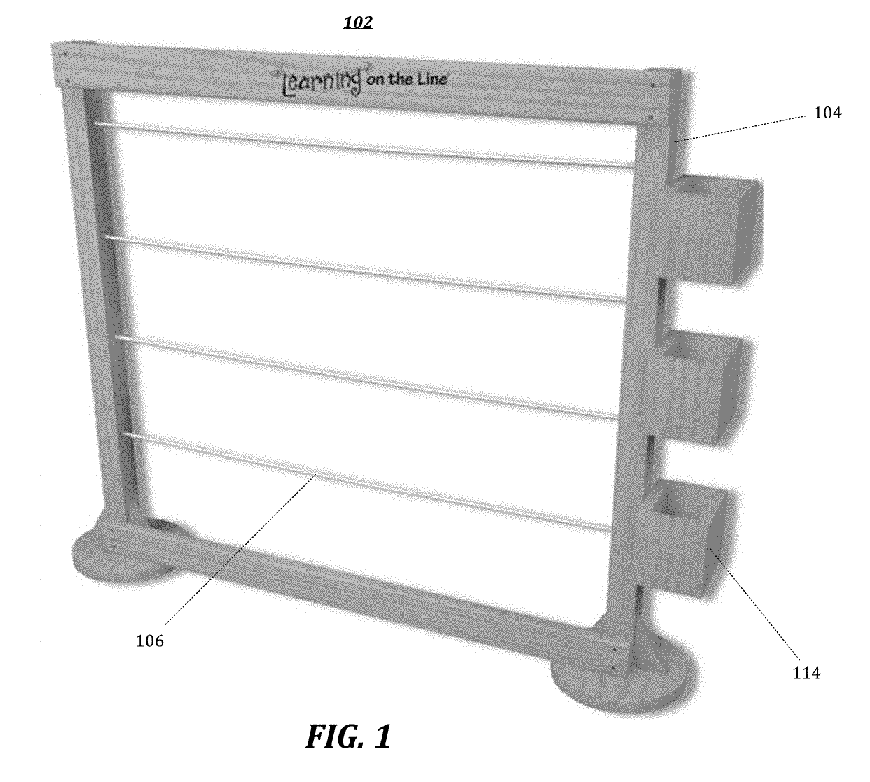

In further aspects, the display assembly comprises at least four display members. In yet further aspects, the display members can comprise a tensile element, string, line, rope, cord, cable, or elongated rod, bar, pole, shaft, or the like. In some aspects, the width of the display members comprises a sufficient length to hang enough cards to complete learning assignments, for example, a length of at least about 44″. In other aspects, the display assembly comprises a height sufficient to accommodate the plurality of display members with enough vertical distance between adjacent display members to accommodate the attached cards, for example, a height of equal to or less than about 44″. In further aspects, FIG. 1 shows a display assembly 102 in accordance with an exemplary embodiment of the present invention. As shown, the display assembly 102 comprises a display frame 104 defining an outer edge of the display assembly 102; and four display members 106 being contained within the display assembly edge. The display assembly 102 also has multiple receptacles 114 for storing cards, securing means, and the like.

In various aspects, the components of the disclosed devices can be integrally connected, or releasably connected. In further aspects, the components can be connected by a connecting means. In still further aspects, the connecting means can comprise a fitting, insert, adhesive, brazing, soldering, welding, spot weld, screw with nut, rivet, threading, friction fit, snap-fit, twist-lock, or interlocking mechanism or a combination thereof. In yet further aspects, the connection can be achieved using a snap, friction fitting, snap ring, O-ring, pressure fitting, clip, clasp, and the like. The snap ring or O-ring can be retained within a groove to accommodate the snap ring or O-ring. In a further aspect, the system can comprise an engagement means for coupling and holding components together. In a further aspect, the engagement means can be a screwing mechanism, a click-lock mechanism, or friction mechanism, or the like.

In still further aspect, the components can be integrally or mechanically attached to other components. In a yet further aspect, the disclosed components can be connected, attached, or mounted using a connecting means, the connecting means comprising a fitting, insert, adhesive, brazing, soldering, welding, spot weld, screw with nut, rivet, fitting, insert, threading, friction fit, or snap-fit or a combination thereof.

In various aspects, the disclosed devices and system can comprise multiple configurations. In further aspects, the system can comprise a uniform theme among the system components, for example, related to an activity, to facilitate card relationship identification and thereby promote learning. In still further aspects, the cards, the securing means, and display members can comprise a predetermined shape or appearance.

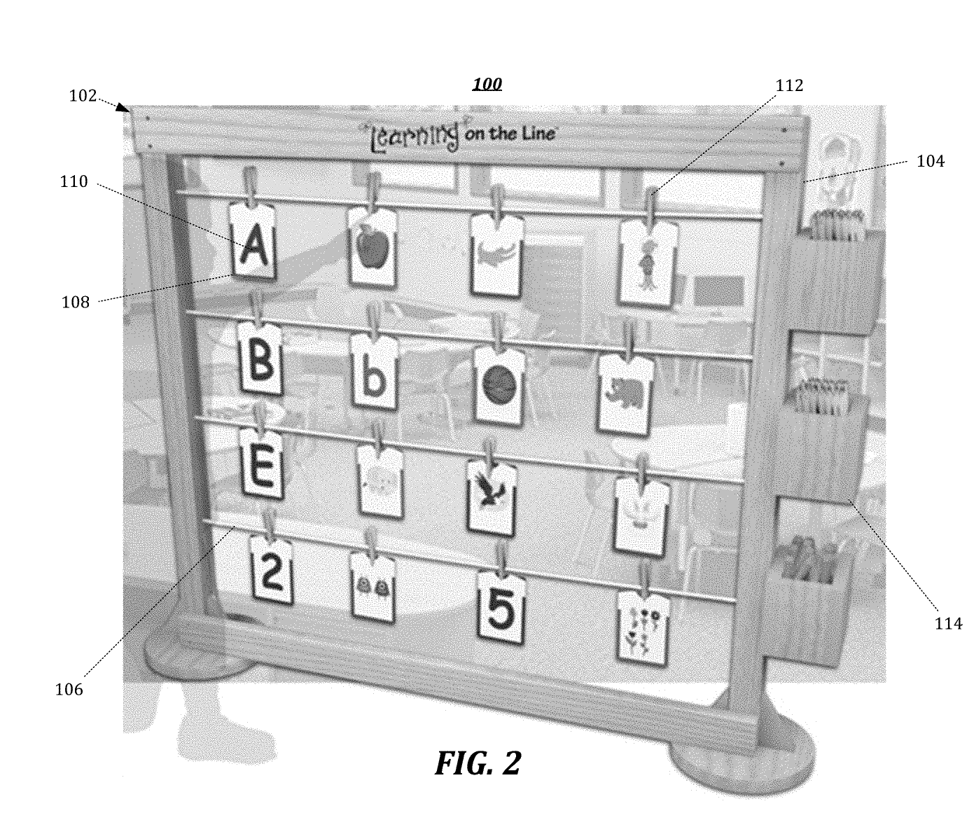

FIG. 2 shows an interactive display system 100 in accordance with an exemplary embodiment of the present invention. As shown, the interactive display system 100 comprises display assembly 102 comprises a display frame 104 defining an outer edge of the display assembly 102; four display members 106 being contained within the display assembly edge; multiple receptacles 114 on the display frame 104 for storing cards, securing means, and the like; a plurality of cards 108 comprising indicia 110 disposed on at least one surface of the card 108, the cards 108 being configured to be releasably attached to the display members 106 in an attachment pattern; and a plurality of securing means 112 configured to releasably attach the cards 108 to the display members 106.

In further aspects, the cards 108 and card indicia 110 are configured to communicate information for use by the user or student in determining a card attachment position in an attachment pattern. As further described in FIG. 2, the display system 100 can have a laundry theme where the cards 108 can comprise the shape or appearance of a clothing garment (e.g., T-shirt), the securing means 112 comprise the shape or appearance of clothespins, and the display members comprise the shape or appearance of laundry lines.

Accordingly, the display devices and system of the present disclosure allows children to practice basic learning skills by providing laundry lines for children to clip the cards on, and the children use clothespins to clip T-shirt cards on the various laundry lines of the display assembly. In further aspects, the T-shirt cards are designed and configured to provide complete lessons in building pre-reading and pre-math skills. To this end, the cards can be selectively attached to the respective display member, using the clothespins allowing for mixing, matching and positioning in unlimited selection and orientation. The display device and system can be adapted to fit any number of cards, subject matter, and attachment configurations.

In various further aspects, the present disclosure also relates to methods of using the disclosed display devices and systems, for example, to teach children pre-math and pre-reading. In still further aspects, the disclosure provides methods fort teaching a child how to determine a relationship between two or more cards. In yet further aspects, also provided are methods for teaching a child how to determine the attachment position of a first card by relating the first card indicia with indicia of another card. In still further aspects, also provided are methods for learning using an interactive display device, the method comprising: providing an interactive display device comprising: a display frame defining an outer edge of the display assembly; and a plurality of display members, the display members being contained within the display assembly edge; providing a plurality of cards comprising indicia disposed on at least one surface of the card, the cards being configured to be releasably attached to the display members in an attachment pattern; the card indicia being configured to communicate information for use in determining a card attachment position in an attachment pattern; and attaching the plurality of cards in an attachment pattern; wherein an attachment position of a card in an attachment pattern is based at least on a predetermined relationship to at least one other card in an adjacent attachment position. In further aspects, the attachment position of a card in an attachment pattern is based at least on a predetermined relationship to a plurality of other cards in adjacent attachment positions.

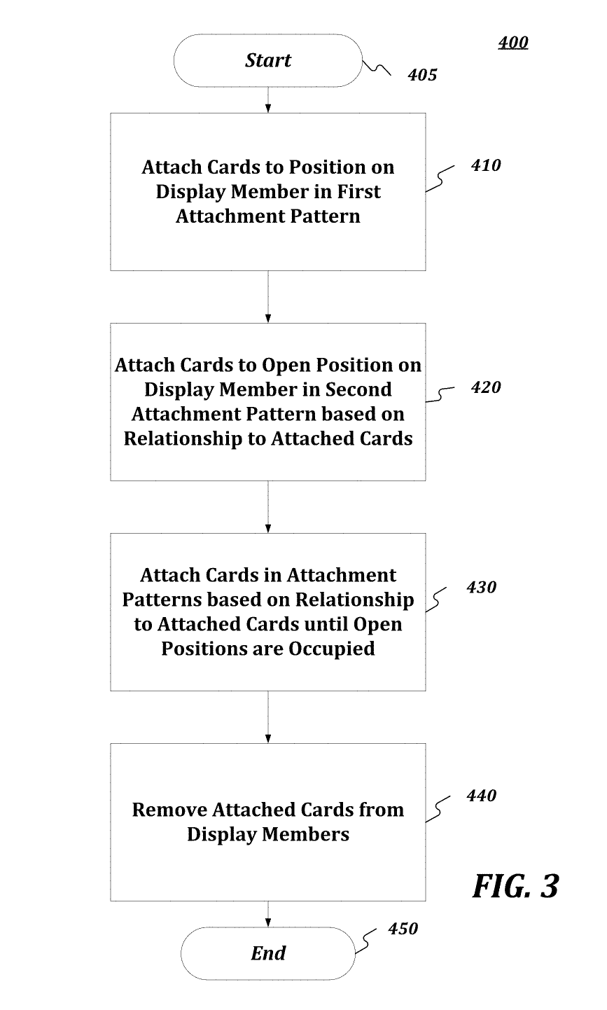

FIG. 3 is a flow chart setting forth the general stages involved in a method 400 consistent with an embodiment of the disclosure for operating the disclosed devices and systems. Method 400 may be implemented using, at least in part, an interactive display system 100 (e.g., display assembly and cards) as described with respect to FIG. 2. Although stages are disclosed with reference to display system 100, it should be understood that a plurality of other components may enable the operation of method 400, including, but not limited to, other mechanical components, user or student conditions, user or student instructions, and the like.

Further still, although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein.

Method 400 may begin at starting block 405 and proceed to stage 410, where one or more cards may be secured by a user to a position on a display member in a first attachment pattern. From stage 410, where the first cards are secured on the display member by a user, method 400 may proceed to stage 420 where one or more cards may be secured by a second user to a position on a display member in a second attachment pattern where the cards are attached adjacent to other cards based on a relationship between indicia displayed on adjacent cards, for example, a letter-word association, letter-word sound association, phonemic association, number association, letter-letter association, numerical value, shape association, sorting, patterning, visual sequencing, or visual discrimination, or the like. The securing of cards, though disclosed in a particular order for illustrative purposes, may occur in other arrangements or patterns.

From stage 420, where cards may be secured by the first user or another user to a display member in a second attachment pattern, method 400 may proceed to stage 430, where additional cards may be secured by additional users to open positions on a display member in additional attachment patterns, based a defined relationship between the adjacent cards, until all the positions on the display members are occupied. From stage 430, where all the positions on the display members are occupied by cards, method 400 may proceed to stage 440, where the cards can be removed from the display members. After stage 440, method 400 may end at stage 450.

In further aspects, the display system 100 can be used to teach initial sounds of letters and pictures. The child and teacher can say the names of the pictures of picture cards together, emphasizing the likeness of the initial sound for each picture. To reinforce the initial sound, the names of the pictures can be repeated, with emphasis placed on the phoneme. For instance, for the picture cards correlating to the “B” or “b” card, the teacher and student would pronounce the letter “B” and then pronounce the words describing the pictures beginning with b, such as ball and bear. Thus, when a picture card correlating to “b” is selected and given to the child, the child know that a correct attachment position would be next to the “B” or “b” card or another “b” word picture card.

In various aspects, an advantage of the invention can be that it allows a user or student to practice basic learning skills through attaching the cards in the appropriate position and patterns based on the card relationships. In further aspects, the cards are configured to provide complete lessons in building pre-reading and pre-math skills, for example, matching letters to pictures, numbers to number sets, recognizing repeating patterns, building and reading graphs, and the like. In still further aspects, the process of attaching cards to the display members also strengthens fine motor skills and improves hand-eye coordination.

The system can be used to teach initial sounds of letters and pictures. The child and teacher can say the names of the pictures of picture cards together, emphasizing the likeness of the initial sound for each picture. To reinforce the initial sound, the names of the pictures can be repeated, with emphasis placed on the phoneme. For instance, for the picture cards correlating to the “B” or “b” card, the teacher and student would pronounce the letter “B” and then pronounce the words describing the pictures beginning with b, such as ball and bear. Thus, when a picture card correlating to “b” is selected and given to the child, the child know that a correct attachment position would be next to the “B” or “b” card or another “b” word picture card.

In further aspects, the concept of order of letters or number can be taught. In yet further aspects, a plurality of cards can be taught to be attached to the display members in an order. In still further aspects, an ordered card sequence can be determined and attached to the display members based on a relationship between the cards in the ordered sequence. In even further aspects, a plurality of ordered card sequences can be attached to the display members. In still further aspects, matching initial sound of a picture card to alphabet card can be taught.

In various aspects, also disclosed herein are kits comprising one or more disclosed device or systems. For example, according to aspects, a kit can comprise a disclosed display device or system and instructions for using the display device or system in conjunction with learning or teaching, such as, for example, children, or the like.

In further aspects, the kit can comprise a kit for teaching comprising: an interactive display device comprising: a display frame defining an outer edge of the display assembly; and a plurality of display members, the display members being contained within the display assembly edge; a plurality of cards comprising indicia disposed on at least one surface of the card, the cards being configured to be releasably attached to the display members in an attachment pattern; the card indicia being configured to communicate information for use in determining a card attachment position in an attachment pattern; and instructions for attaching the plurality of cards in an attachment pattern; wherein an attachment position of a card in an attachment pattern is based at least on a predetermined relationship to at least one other card in an adjacent attachment position.

In further aspects, the instructions may further comprise instructions for determining the attachment position of a card in an attachment pattern based at least on a predetermined relationship to a plurality of other cards in adjacent attachment positions. In still further aspects, the instructions further comprise instructions for determining a relationship between one or more cards based at least on the card information.

In various aspects, the disclosed devices and methods provide numerous advantages over current solutions. In further aspects, the disclosed devices and methods provide new solutions for teaching children that provides children with stimulating, hands-on experiences as they discover the desired subject matter. In still further aspects, the process of attaching the cards to the display members not only encourages learning, but it is also believed to strengthen fine motor skills and improve hand-eye coordination.

The present invention includes at least the following aspects:

Aspect 1: An interactive display system for teaching and educating a child, the system comprising: a) a display assembly comprising: i) a display frame defining an outer edge of the display assembly; and ii) a plurality of display members, the display members being contained within the display assembly edge; b) a plurality of cards comprising indicia disposed on at least one surface of the card, the cards being configured to be releasably attached to the display members in an attachment pattern; and c) a plurality of securing means configured to releasably attach the cards to the display members; wherein the card indicia are configured to communicate information for use in determining a card attachment position in the attachment pattern.

Aspect 2: The system of any preceding aspect, wherein the attachment pattern comprises a plurality of attachment positions on the display members.

Aspect 3: The system of any preceding aspect, wherein each card has a predetermined relationship to a card in an adjacent attachment position.

Aspect 4: The system of any preceding aspect, wherein the attachment position of a card in an attachment pattern is based at least on a predetermined relationship to at least one other card in an adjacent attachment position.

Aspect 5: The system of any preceding aspect, wherein the attachment position of a card in an attachment pattern is based at least on a predetermined relationship to a plurality of other cards in adjacent attachment positions.

Aspect 6: The system of any preceding aspect, wherein the card information can be used in determining a relationship between one or more cards.

Aspect 7: The system of any preceding aspect, wherein the card indicia comprise at least one of: an alphanumerical character, object, shape, picture, symbol, icon, color, media, and combinations thereof.

Aspect 8: The system of any preceding aspect, wherein the relationship comprises at least one of a letter-word association, letter-word sound association, phonemic association, number association, letter-letter association, numerical value, shape association, color association, sorting, patterning, visual sequencing, and visual discrimination, and combinations thereof.

Aspect 9: The system of any preceding aspect, wherein the relationship comprises at least one card having a predetermined letter of a predetermined alphabet and at least one card having a predetermined picture selected from at least one of an object, a person, an animal, and thing being identifiable by a word which is spelled having a first letter identical to the predetermined letter.

Aspect 10: The system of any preceding aspect, wherein the relationship comprises a first card having a predetermined picture selected from of at least one of an object, a person, an animal, and a thing being identifiable by a word having a first letter, and at least one other card having a predetermined picture of at least one of an object, a person, an animal, and a thing being describable by a word which is spelled using the same first letter from the first card.

Aspect 11: The system of any preceding aspect, wherein the relationship comprises at least one card having a predetermined numerical character and at least one card having a predetermined picture of a predetermined number of at least one of an object, a person, an animal, and a thing; wherein the predetermined number of the at least one object, person, animal, and thing is equal to the predetermined numerical character.

Aspect 12: The system of any preceding aspect, wherein the card comprises at least one of alphabet cards, picture cards, number cards, and combinations thereof.

Aspect 13: The system of any preceding aspect, wherein each alphabet card comprises at least one of uppercase and lowercase versions of at least one of a letter, consonant and vowel.

Aspect 14: The system of any preceding aspect, wherein consonant cards and vowel cards can comprise different colors.

Aspect 15: The system of any preceding aspect, wherein uppercase cards and lowercase cards can comprise different colors.

Aspect 16: The system of any preceding aspect, wherein pictures are selected so that the descriptive word for each picture starts with the same letter. For example, picture cards corresponding to letter card “A” show an apple, an ant, and an alien. Picture cards corresponding to letter card “E” show an elephant, an eagle, and an egg.

Aspect 17: The system of any preceding aspect, wherein a consonant letter is selected from at least one of the uppercase and lowercase consonants B, C, D, F, G, H, J, K, L, M, NP, Q, R, S, T, V, W, X, Y, Z.

Aspect 18: The system of any preceding aspect, wherein a vowel letter is selected from at least one of the uppercase and lowercase vowels A, E, I, O, and U.

Aspect 19: The system of any preceding aspect, wherein the display assembly further comprises at least one receptacle for storing the cards, securing means, or combinations thereof.

Aspect 20: The system of any preceding aspect, wherein the display assembly comprises a plurality of receptacles.

Aspect 21: The system of any preceding aspect, wherein the storage receptacles are disposed on an outer edge of the display frame.

Aspect 22: The system of any preceding aspect, wherein the display frame is comprised of a rigid material.

Aspect 23: The system of any preceding aspect, wherein the rigid material comprises a metal, wood, or thermoplastic, or a combination thereof.

Aspect 24: The system of any preceding aspect, wherein the display frame is in the shape of a square, rectangle, polygon, isosoles trapezoid, or a combination thereof.

Aspect 25: The system of any preceding aspect, wherein the display frame comprises a plurality of connected frame elements.

Aspect 26: The system of any preceding aspect, wherein the frame elements are connected by a coupling means.

Aspect 27: The system of any preceding aspect, wherein the coupling means comprise a fitting, flange, joint, coupling, insert, threading, friction fit, snap-fit or other suitable type of connecting mechanism, or a combination thereof.

Aspect 28: The system of any preceding aspect, wherein the securing means comprises a clamp, clip, clasp, pin, strap, hooks, snap, band, fastener, or other suitable type of releasable attachment mechanism, or a combination thereof.

Aspect 29: The system of any preceding aspect, wherein the display assembly comprises at least four display members.

Aspect 30: The system of any preceding aspect, wherein the display members can comprise at least one of a tensile element, string, line, rope, cord, cable, elongated rod, bar, pole, shaft, and the like.

Aspect 31: The system of any preceding aspect, wherein the width of the display members comprises a sufficient length to hang enough cards to complete learning assignments.

Aspect 32: The system of any preceding aspect, wherein each display member comprises at least two attachment positions for securing cards.

Aspect 33: The system of any preceding aspect, wherein each display member comprises at least three attachment positions for securing cards.

Aspect 34: The system of any preceding aspect, wherein each display member comprises at least four attachment positions for securing cards.

Aspect 35: The system of any preceding aspect, wherein each display member comprises at least five attachment positions for securing cards.

Aspect 36: The system of any preceding aspect, wherein the display assembly comprises a height sufficient to accommodate the plurality of display members with enough vertical distance between adjacent display members to accommodate the attached cards.

Aspect 37: The system of any preceding aspect, wherein the system can comprise a uniform theme among the cards, for example, related to an activity, to facilitate card relationship identification and thereby promote learning.

Aspect 38: The system of any preceding aspect, wherein the cards, the securing means, and display members can comprise a predetermined shape or appearance.

Aspect 39: The system of any preceding aspect, wherein the cards comprise the shape or appearance of a clothing garment (e.g., T-shirt), the securing means comprise the shape or appearance of clothespins, and the display members comprise the shape or appearance of laundry lines.

Aspect 40: The system of any preceding aspect, wherein the display assembly allows children to practice basic learning skills by providing laundry lines for children to clip the cards on, and the children use clothespins to clip T-shirt cards on the various laundry lines of the display assembly.

Aspect 41: The system of any preceding aspect, further configured to teach a child how to determine a relationship between two or more cards.

Aspect 42: The system of any preceding aspect, further configured to teach a child how to determine the attachment position of a first card by relating the first card indicia with indicia of another card.

Aspect 43: The system of any preceding aspect, further configured to teach a child how to determine the attachment position of a first card by relating the first card indicia with indicia of an attached card.

Aspect 44: The system of any preceding aspect, further configured to teach the concept of order of letters.

Aspect 45: The system of any preceding aspect, wherein a plurality of cards is attached to the display members in an order.

Aspect 46: The system of any preceding aspect, wherein an ordered card sequence is determined and attached to the display members based on a relationship between the cards in the ordered sequence.

Aspect 47: The system of any preceding aspect, wherein a plurality of ordered card sequences is attached to the display members.

Aspect 48: The system of any preceding aspect, further comprising teaching a child matching initial sound of a picture card to an alphabet card.

Aspect 49: A method for learning using an interactive display device, the method comprising: a) providing an interactive display device comprising: i) a display frame defining an outer edge of the display assembly; and ii) a plurality of display members, the display members being contained within the display assembly edge; b) providing a plurality of cards comprising indicia disposed on at least one surface of the card, the cards being configured to be releasably attached to the display members in an attachment pattern; the card indicia being configured to communicate information for use in determining a card attachment position in an attachment pattern; and c) attaching the plurality of cards in an attachment pattern; wherein an attachment position of a card in an attachment pattern is based at least on a predetermined relationship to at least one other card in an adjacent attachment position.

Aspect 50: The method of any preceding aspect, wherein the attachment position of a card in an attachment pattern is based at least on a predetermined relationship to a plurality of other cards in adjacent attachment positions.

Aspect 51: The method of any preceding aspect, wherein the attachment pattern comprises a plurality of attachment positions on the display members.

Aspect 52: The method of any preceding aspect, wherein the card information can be used in determining a relationship between one or more cards.

Aspect 53: The method of any preceding aspect, wherein the card indicia comprise at least one of: an alphanumerical character, object, shape, picture, symbol, icon, color, media, and combinations thereof.

Aspect 54: The method of any preceding aspect, wherein the relationship comprises at least one of a letter-word association, letter-word sound association, phonemic association, number association, letter-letter association, numerical value, shape association, color association, sorting, patterning, visual sequencing, and visual discrimination, and combinations thereof.

Aspect 55: The method of any preceding aspect, wherein the relationship comprises at least one card having a predetermined letter of a predetermined alphabet and at least one card having a predetermined picture selected from at least one of an object, a person, an animal, and thing being identifiable by a word which is spelled having a first letter identical to the predetermined letter.

Aspect 56: The method of any preceding aspect, wherein the relationship comprises a first card having a predetermined picture selected from of at least one of an object, a person, an animal, and a thing being identifiable by a word having a first letter, and at least one other card having a predetermined picture of at least one of an object, a person, an animal, and a thing being describable by a word which is spelled using the same first letter from the first card.

Aspect 57: The method of any preceding aspect, wherein the relationship comprises at least one card having a predetermined numerical character and at least one card having a predetermined picture of a predetermined number of at least one of an object, a person, an animal, and a thing; wherein the predetermined number of the at least one object, person, animal, and thing is equal to the predetermined numerical character.

Aspect 58: The method of any preceding aspect, wherein the card comprises at least one of alphabet cards, picture cards, number cards, and combinations thereof.

Aspect 59: The method of any preceding aspect, wherein each alphabet card comprises at least one of uppercase and lowercase versions of at least one of a letter, consonant and vowel.

Aspect 60: The method of any preceding aspect, wherein consonant cards and vowel cards can comprise different colors.

Aspect 61: The method of any preceding aspect, wherein uppercase cards and lowercase cards can comprise different colors.

Aspect 62: The method of any preceding aspect, wherein pictures are selected so that the descriptive word for each picture starts with the same letter. For example, picture cards corresponding to letter card “A” show an apple, an ant, and an alien. Picture cards corresponding to letter card “E” show an elephant, an eagle, and an egg.

Aspect 63: The method of any preceding aspect, wherein a consonant letter is selected from at least one of the uppercase and lowercase consonants B, C, D, F, G, H, J, K, L, M, N P, Q, R, S, T, V, W, X, Y, Z.

Aspect 64: The method of any preceding aspect, wherein a vowel letter is selected from at least one of the uppercase and lowercase vowels A, E, I, O, and U.

Aspect 65: The method of any preceding aspect, further comprising determining the attachment position of a first card by relating the first card indicia with indicia of another card, thereby learning the relationship between the cards.

Aspect 66: The method of any preceding aspect, further comprising determining the attachment position of a first card by relating the first card indicia with indicia of an attached card, thereby learning the relationship between the cards.

Aspect 67: The method of any preceding aspect, wherein determining the attachment position is based at least upon matching an initial sound of a picture card to a corresponding letter of an alphabet card.

Aspect 68: A kit for teaching, the kit comprising: a) an interactive display device comprising: i) a display frame defining an outer edge of the display assembly; and ii) a plurality of display members, the display members being contained within the display assembly edge; b) a plurality of cards comprising indicia disposed on at least one surface of the card, the cards being configured to be releasably attached to the display members in an attachment pattern; the card indicia being configured to communicate information for use in determining a card attachment position in an attachment pattern; and c) instructions for attaching the plurality of cards in an attachment pattern; wherein an attachment position of a card in an attachment pattern is based at least on a predetermined relationship to at least one other card in an adjacent attachment position.

Aspect 69: The kit of any preceding aspect, wherein the instructions further comprise instructions for determining the attachment position of a card in an attachment pattern based at least on a predetermined relationship to a plurality of other cards in adjacent attachment positions.

Aspect 70: The kit of any preceding aspect, wherein the attachment pattern comprises a plurality of attachment positions on the display members.

Aspect 71: The kit of any preceding aspect, wherein the instructions further comprise instructions for determining a relationship between one or more cards based at least on the card information.

Aspect 72: The kit of any preceding aspect, wherein the card indicia comprise at least one of: an alphanumerical character, object, shape, picture, symbol, icon, color, media, and combinations thereof.

Aspect 73: The kit of any preceding aspect, wherein the relationship comprises at least one of a letter-word association, letter-word sound association, phonemic association, number association, letter-letter association, numerical value, shape association, color association, sorting, patterning, visual sequencing, and visual discrimination, and combinations thereof.

Aspect 74: The kit of any preceding aspect, wherein the relationship comprises at least one card having a predetermined letter of a predetermined alphabet and at least one card having a predetermined picture selected from at least one of an object, a person, an animal, and thing being identifiable by a word which is spelled having a first letter identical to the predetermined letter.

Aspect 75: The kit of any preceding aspect, wherein the relationship comprises a first card having a predetermined picture selected from of at least one of an object, a person, an animal, and a thing being identifiable by a word having a first letter, and at least one other card having a predetermined picture of at least one of an object, a person, an animal, and a thing being describable by a word which is spelled using the same first letter from the first card.

Aspect 76: The kit of any preceding aspect, wherein the relationship comprises at least one card having a predetermined numerical character and at least one card having a predetermined picture of a predetermined number of at least one of an object, a person, an animal, and a thing; wherein the predetermined number of the at least one object, person, animal, and thing is equal to the predetermined numerical character.

Aspect 77: The kit of any preceding aspect, wherein the card comprises at least one of alphabet cards, picture cards, number cards, and combinations thereof.

Aspect 78: The kit of any preceding aspect, wherein each alphabet card comprises at least one of uppercase and lowercase versions of at least one of a letter, consonant and vowel.

Aspect 79: The kit of any preceding aspect, wherein consonant cards and vowel cards can comprise different colors.

Aspect 80: The kit of any preceding aspect, wherein uppercase cards and lowercase cards can comprise different colors.

Aspect 81: The kit of any preceding aspect, wherein pictures are selected so that the descriptive word for each picture starts with the same letter. For example, picture cards corresponding to letter card “A” show an apple, an ant, and an alien. Picture cards corresponding to letter card “E” show an elephant, an eagle, and an egg.

Aspect 82: The kit of any preceding aspect, wherein a consonant letter is selected from at least one of the uppercase and lowercase consonants B, C, D, F, G, H, J, K, L, M, N P, Q, R, S, T, V, W, X, Y, Z.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. An interactive display system for teaching and educating a child, the system comprising:
a) a display assembly comprising:
i) a display frame defining an outer edge of the display assembly; and
ii) a plurality of display members, the display members being contained within the display assembly edge;
b) a plurality of cards comprising indicia disposed on at least one surface of the card, the cards being configured to be releasably attached to the display members in an attachment pattern; the card indicia being configured to communicate information for use in determining a card attachment position in an attachment pattern; and
c) a plurality of securing means configured to releasably attach the cards to the display members;
wherein the card indicia are configured to communicate information for use in determining a card attachment position in the attachment pattern.

2. The system of claim 1, wherein the attachment position of a card in an attachment pattern is based at least on a predetermined relationship to at least one other card in an adjacent attachment position.

3. The system of claim 2, wherein the attachment position of a card in an attachment pattern is based at least on a predetermined relationship to a plurality of other cards in adjacent attachment positions.

4. The system of claim 3, wherein the card indicia comprise at least one of: an alphanumerical character, object, shape, picture, symbol, icon, color, media, and combinations thereof.

5. The system of claim 4, wherein the predetermined relationship comprises at least one of a letter-word association, letter-word sound association, phonemic association, number association, letter-letter association, numerical value, shape association, color association, sorting, patterning, visual sequencing, and visual discrimination, and combinations thereof.

6. The system of claim 5, wherein the predetermined relationship comprises at least one card having a predetermined letter of a predetermined alphabet and at least one card having a predetermined picture selected from at least one of an object, a person, an animal, and thing being identifiable by a word which is spelled having a first letter identical to the predetermined letter.

7. The system of claim 5, wherein the relationship comprises a first card having a predetermined picture selected from of at least one of an object, a person, an animal, and a thing being identifiable by a word having a first letter, and at least one other card having a predetermined picture of at least one of an object, a person, an animal, and a thing being describable by a word which is spelled using the same first letter from the first card.

8. The system of claim 5, wherein the relationship comprises at least one card having a predetermined numerical character and at least one card having a predetermined picture of a predetermined number of at least one of an object, a person, an animal, and a thing; wherein the predetermined number of the at least one object, person, animal, and thing is equal to the predetermined numerical character.

9. The system of claim 5, further configured to teach a child how to determine the attachment position of a first card by relating the first card indicia with indicia of another card.

10. The system of claim 5, further configured to teach a child how to determine the attachment position of a first card by relating the first card indicia with indicia of an attached card.

11. A method for learning using an interactive display device, the method comprising:
a) providing an interactive display device comprising:
i) a display frame defining an outer edge of the display assembly; and
ii) a plurality of display members, the display members being contained within the display assembly edge;
b) providing a plurality of cards comprising indicia disposed on at least one surface of the card, the cards being configured to be releasably attached to the display members in an attachment pattern; the card indicia being configured to communicate information for use in determining a card attachment position in an attachment pattern; and
c) attaching the plurality of cards in an attachment pattern;
wherein an attachment position of a card in an attachment pattern is based at least on a predetermined relationship to at least one other card in an adjacent attachment position.

12. The method of claim 11, wherein the attachment position of a card in an attachment pattern is based at least on a predetermined relationship to a plurality of other cards in adjacent attachment positions.

13. The method of claim 12, wherein the card indicia comprise at least one of: an alphanumerical character, object, shape, picture, symbol, icon, color, media, and combinations thereof.

14. The method of claim 13, wherein the relationship comprises at least one of a letter-word association, letter-word sound association, phonemic association, number association, letter-letter association, numerical value, shape association, color association, sorting, patterning, visual sequencing, and visual discrimination, and combinations thereof.

15. The method of claim 14, further comprising determining the attachment position of a first card by relating the first card indicia with indicia of another card, thereby learning the relationship between the cards.

16. The method of claim 14, further comprising determining the attachment position of a first card by relating the first card indicia with indicia of an attached card, thereby learning the relationship between the cards.

17. A kit for teaching, the kit comprising:
a) an interactive display device comprising:
i) a display frame defining an outer edge of the display assembly; and
ii) a plurality of display members, the display members being contained within the display assembly edge;
b) a plurality of cards comprising indicia disposed on at least one surface of the card, the cards being configured to be releasably attached to the display members in an attachment pattern; the card indicia being configured to communicate information for use in determining a card attachment position in an attachment pattern; and
c) instructions for attaching the plurality of cards in an attachment pattern; wherein an attachment position of a card in an attachment pattern is based at least on a predetermined relationship to at least one other card in an adjacent attachment position.

18. The kit of claim 17, wherein the instructions further comprise instructions for determining the attachment position of a card in an attachment pattern based at least on a predetermined relationship to a plurality of other cards in adjacent attachment positions.

19. The kit of claim 18, wherein the card indicia comprise at least one of: an alphanumerical character, object, shape, picture, symbol, icon, color, media, and combinations thereof.

20. The kit of claim 20, wherein the relationship comprises at least one of a letter-word association, letter-word sound association, phonemic association, number association, letter-letter association, numerical value, shape association, color association, sorting, patterning, visual sequencing, and visual discrimination, and combinations thereof.
